(19) United States
(12) Patent Application Publication
(10) Pub. No.: US 2023/0371634 A1
(43) Pub. Date: Nov. 23, 2023

(54) SYSTEMS AND METHODS FOR CREATING GARMENTS TO COMPENSATE FOR ANATOMICAL ASYMMETRY

(71) Applicant: Mayo Foundation for Medical Education and Research, Rochester, MN (US)

(72) Inventor: Sarvam P. TerKonda, Jacksonville, FL (US)

(21) Appl. No.: 18/027,520

(22) PCT Filed: Nov. 9, 2021
(86) PCT No.: PCT/US2021/058628

§ 371 Date: Mar. 21, 2023

Related U.S. Application Data
(60) Provisional application No. 63/115,796, filed on Nov. 19, 2020.

(51) Int. Cl. A41H 3/00; A41C 5/00; B33Y 10/00; B33Y 30/00; B33Y 50/00

(52) U.S. Cl. CPC A41H 3/007; A41C 5/00; B33Y 10/00; B33Y 30/00; B33Y 50/00

(57) ABSTRACT

Systems and methods can be used for imaging breasts and for designing and manufacturing custom bras or garments for a subject with breast asymmetry. For example, disclosed herein is a method for capturing multiple images of the subject and processing images into a digital model representing the 3D structure of the breasts of the subject. The system processes the digital model to determine characteristics of the subject's breasts and chest wall including volume, shape, protrusion, and asymmetry. The subject inputs preferences and transmits the preferences and digital model to a networked additive manufacturing device for construction of customized bra components or other garments.

### CLAIM OF PRIORITY

This application claims priority under 35 USC §119(e) to U.S. patent application Ser. No. 63/115,796, filed on Nov. 19, 2020, the entire contents of which are hereby incorporated by reference.

### FIELD OF THE DISCLOSURE

The disclosure relates to garment design and manufacture. In some examples, this disclosure relates to systems and methods for designing and manufacturing customized asymmetric breast garments based upon three-dimensional scanning

### BACKGROUND

Many women experience a form of anatomical asymmetry, such as breast asymmetries, including natural asymmetries, congenital deformities and asymmetries following surgery. Post-surgical asymmetries can result from functional procedures such as breast reductions, partial or total mastectomies as a result of a breast cancer diagnosis or from aesthetic procedures such as breast lifts or augmentations. Difference in size, shape, projection, or position between the right and left breasts characterize breast asymmetries. Asymmetries in the chest wall can exacerbate these differences.

Elective reconstructive or aesthetic surgical procedures are frequently performed to create symmetry, however, only partially successful in reducing the asymmetry.

Currently, bras and like garments are manufactured using a symmetric manufacturer-standardized sizing system that does not include variations in individual cup size, underlying support or band width to account for breast and/or chest asymmetries.

### SUMMARY

This disclosure describes systems and methods for imaging breasts. As used herein, the term “breast” encompasses any portion of a human breast or chest feature, such as a pectoral muscle. This disclosure describes systems and methods for designing and manufacturing custom bras and garments using additive manufacturing, e.g., a 3D printer. For example, disclosed herein is a mobile device application installed on a user device and image processing system which receives multiple images or video of a user and processes the image into a digital model representing the 3D structure of the body of a user. The mobile application can identify parts of a body, such as breasts and/or chest of a user. The system processes the digital model to determine characteristics of the user breasts and chest wall including volume, shape, projection, position, and asymmetry. The user inputs preferences into the user device and transmits the preferences and digital model to a networked additive manufacturing device for construction of customized garments for a user experiencing breast and/or chest asymmetry.

In one aspect, this disclosure is directed to a method that includes: (i) receiving, by a computing system, multiple digital images of a torso of a subject that has a anatomical asymmetry; (ii) processing, by the computing system, the multiple digital images to create a digital three-dimensional model of the anatomical asymmetry; and (iii) creating, based on the model and using an additive manufacturing process, one or more components of a bra for the subject that reduces an appearance of the anatomical asymmetry.

Such a method may optionally include one or more of the following features.

The method can further include assembling the garment including the one or more components. The anatomical asymmetry can be a breast asymmetry, or a chest asymmetry. The garment can be a bra, a swimsuit, a blouse, a lingerie, an athletic wear, a protective sportswear, or a gown. The multiple digital images of the torso of the subject may include three or more digital images at differing angles between the torso of the subject and a camera that captures the three or more digital images. Additionally, images may be captured with a video enabled device. The processing may be performed using computer vision and a machine learning model. The machine learning model may be a supervised machine learning model. The machine learning model may be an unsupervised machine learning model. The machine learning model may be a computer vision model. The processing may include morphological image processing to extract image components representing anatomical components of the subject. The processing may include body identification that selects data from the model. The digital model may be a digital three-dimensional model. The multiple digital images of the torso of the subject may include a video having three or more digital images at differing angles between the torso of the subject and a camera that captures the three or more digital images.

In another aspect, this disclosure is directed to a system for customized bra component manufacturing. The system includes: a digital camera, a computing system, and an additive manufacturing process. The computing system is configured to: (a) receive multiple digital images of a torso of a subject that has an anatomical asymmetry, wherein the multiple digital images are captured by the digital camera; and (b) process the multiple digital images to create a digital model of the anatomical asymmetry. The additive manufacturing process is configured to create, based on the model, one or more components of a bra for the subject that reduces an appearance of the anatomical asymmetry.

Such a system may optionally include one or more of the following features. The additive manufacturing process may further include assembling the garment including the one or more components. The anatomical asymmetry may be a breast asymmetry, or a chest asymmetry. The garment may be a bra, a swimsuit, a blouse, a lingerie, an athletic wear, a protective sportswear, or a gown. The digital model may be a digital three-dimensional model. The digital camera may be a component of a smart phone, tablet computer, or other mobile device. The computing system may be partially located on the smart phone or tablet computer and partially located on one or more other computer systems. The computing system may be fully located on the smart phone or tablet computer. The additive manufacturing process may comprise a three-dimensional printer. The digital camera may be a video camera. The multiple digital images may be from a video captured by the video camera.

In another aspect, this disclosure is directed to a non-transitory computer readable storage device storing instructions that, when executed by at least one processor, cause the at least one processor to perform operations including (a) receiving, by a computing system, multiple digital images of a torso of a subject that has an anatomical asymmetry; (b) processing, by the computing system, the multiple digital images to create a digital three-dimensional model of the anatomical asymmetry; and (c) creating, based on the model and using an additive manufacturing process, one or more components of a garment for the subject that reduces an appearance of the anatomical asymmetry.

### BRIEF DESCRIPTION OF THE DRAWINGS

FIGS. 1A-1E are diagrams depicting five exemplary categories of breast asymmetries.

FIG. 2 is a flow diagram of an overview of 3D printing of customized bras.

FIGS. 3A and 3B are flow diagrams of processes to obtain an image or video of the user torso.

FIG. 4 is a diagram depicting user positioning during image or video capture.

FIG. 5 is a flow diagram of the process to generate a differential digital model from captured images.

FIG. 6 is an image of a generated digital model.

FIG. 7 is a flow diagram of the process to 3D print bra components from a differential digital model.

FIG. 8 is a schematic diagram of example user devices, such as a computing device and a mobile computing device.

In the figures, like symbols indicate like elements.

### DETAILED DESCRIPTION

This disclosure describes systems and methods for imaging breasts and for designing and manufacturing custom garments using additive manufacturing, e.g., a 3D printer. As used herein, the term “garment” refers to bras and other like garments, such as swimwear, athletic wear or lingerie.

Ready-to-wear bras are manufactured in standardized, symmetric combinations of breast cup, underlying support, and band sizes. Mass production of standardized bras does not account for bra cup, under lying support (e.g., underwire) or band customization to correct breast or chest asymmetries. Ready-to-wear garments designed to fit standardized analog sizes result in suboptimal fitting as breast and chest shape, size, and asymmetries vary along a continuum.

Disclosed herein is an application in communication with a 3D printing platform for the manufacture of customized garments (e.g., bras, swimsuits, blouses, gowns, etc.) for the correction of breast and chest asymmetries.

The systems and methods disclosed herein are not limited to breast asymmetry correction and can be used to address other anatomical asymmetries such as facial features, body or extremity asymmetries. Additionally, customized garments can further include lingerie, swimwear, athletic wear, and protective sportswear. Currently, companies produce symmetric breast support structures, such as underwire or cup support devices, designed to achieve overall comfort and fit for symmetrically-proportioned users. These structures do not address asymmetry between anatomical features, including the right and left breast. The disclosed system allows for creating of a user-specific digital model of the torso and customized three-dimensional (3D) printing of bras that would accommodate and/or correct asymmetries, including natural or surgical asymmetries.

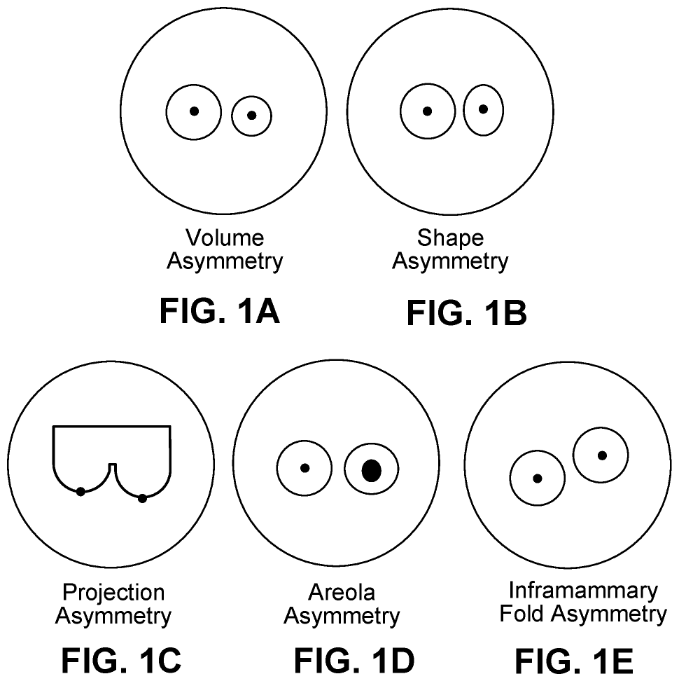

FIGS. 1A-1E are diagrams depicting five exemplary categories of breast asymmetries for which the disclosed system can advantageously produce customized breast support structures. Asymmetries of the breast and/or chest can result from natural variances, congenital deformities or post-surgical changes. FIG. 1A depicts an example of breast volume asymmetry, e.g., difference in size. Volume asymmetries of the breast can be noted in volume differences as minimal as 20-30 cc. FIG. 1B depicts an example of shape asymmetry (e.g., difference in shape), for example, round, oblong, or conical shapes. FIG. 1C is a top view depicting an example of projection asymmetry, e.g., difference in breast projection distance from the chest wall. FIG. 1D depicts an example of areolar asymmetry, e.g., difference in areola size or position. FIG. 1E depicts an example of inframammary fold asymmetry, e.g., difference in position of the anatomic landmark between the base of the breast to the chest wall.

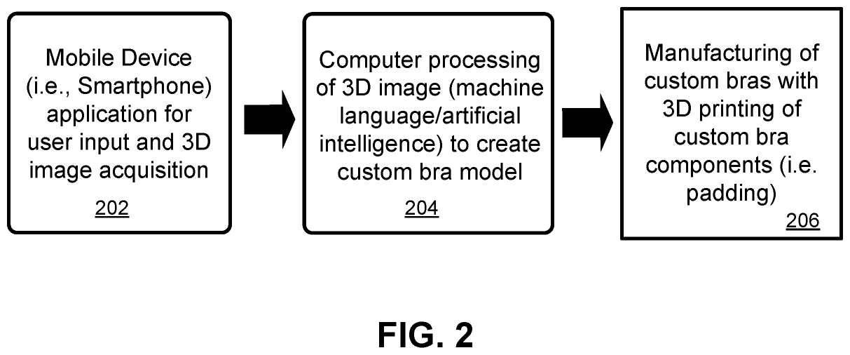

FIG. 2 is a high-level flow diagram illustrating the system and method for developing and manufacturing customized bras to thereby create a customized product for a user with breast asymmetry. The system includes an application for use on a user device (e.g., a mobile device, tablet, laptop, etc.), image processing, and additive manufacturing (e.g., using a 3D printer).

In some embodiments, a user installs and interacts with an application on a user device (e.g., a smailphone, tablet, laptop, computer) to obtain images of the user breasts (in box 202). The application features a user interface and, in some embodiments, the user interface is designed to meet industry standard practices for ease of use (e.g., Apple® design standards). The user device displays a login screen to the user wherein the user creates or inputs a username In some implementations, the user creates or inputs a password. The application receives the username and/or password and compares the username and/or password to a database of usernames and passwords stored on the user device memory or remote server. In some implementations, the username and/or password is cryptographically encoded before being stored in the user device memory. The username and/or password is cryptographically encoded before being compared to the database of usernames and passwords stored on the user device memory.

In some embodiments, the application stores additional user data (e.g., personal data) on the user device memory, including for example height, weight, age, BMI, breast asymmetries, breast image data, and order data. In some embodiments, the user data is stored according to industry standard practices to maintain compliance with a data privacy governing body (e.g., HIPAA compliant).

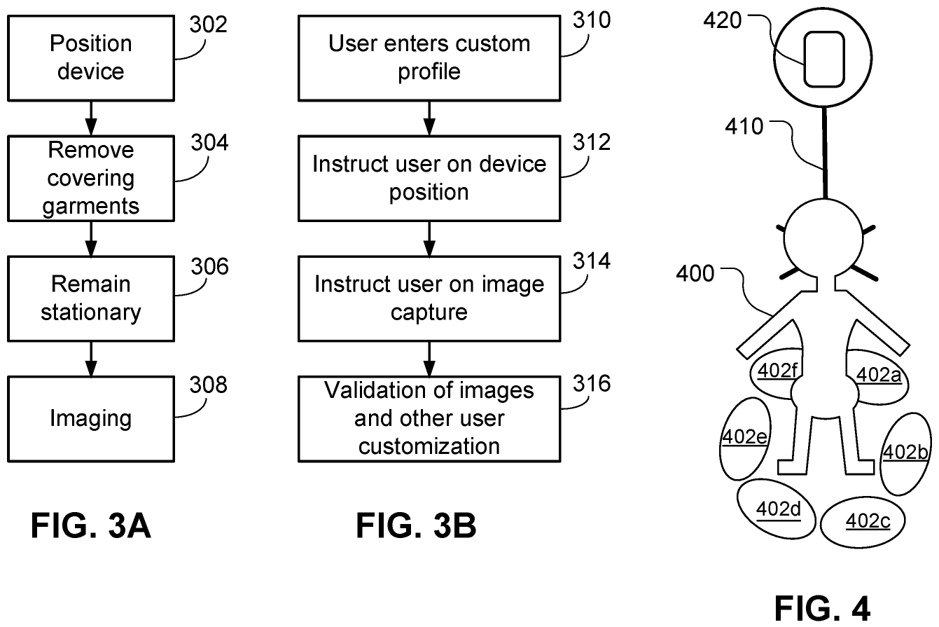

The application further features processes for image collection and data de-identification (e.g., removal of identifying personal information). Further details on image collection are shown in FIG. 3.

Still referring to FIG. 2, in box 204 the mobile application then creates a digital model for differential analysis of the left and right breast thereby distinguishing differences in breast characteristics, e.g., volume, shape, position, as well as other properties. In some implementations, the digital model is a three-dimensional (3D) digital model including spatial information relating to three spatial dimensions. The process includes a camera-enabled mobile device (e.g., smartphone, tablet, laptop, remote camera, etc.) application to obtain images containing depth information used in calculation of the user's breast measurements. In some embodiments, the digital model is transmitted to a networked computing device for additional image processing (in box 204) which can include the use of machine learning algorithms. A differentiated digital model is calculated based upon the transmitted digital model including labeled anatomical components and approximations of the dimensions and asymmetries of the breasts.

The computing system(s) for image processing can be a single computing system or two or more different computing systems that function in conjunction with each other to process the images.

The digital model is provided/sent to an additive manufacturing or printing system (in box 206) (e.g., 3D printer) to construct customized bra components including structural components such as the underlying support (i.e., underwire) and cup support with differential padding. In some cases, the additive manufacturing system can be networked with the mobile application. Customized design can also include customized padding and fabric to cover the structure components.

Referring now to FIG. 3A, a flow diagram illustrating the process to acquire user breast image data is shown The user positions the user device (in box 304) in a stable location such that the user device camera has an unobstructed view of the user's torso, including left and right breasts, chest walls, sides, and back. The user removes garments covering the breasts, such as a shirt, blouse, dress, or bra.

The user positions the user device such that user's torso is within the camera view. In some embodiments, the user device camera is a forward-facing camera integrated into the display of the user device. In such embodiments, the user device display presents the camera view to the user to aid in positioning and orientation. The user device captures one or more images (or video) of the user's torso (in box 306) and stores the image(s) or video in memory. The sequence of image captures are separated by a time interval sufficient to allow the user to reorient between image captures. For example, the time interval may be five seconds or more (e.g., 10 seconds) between image captures. In between two images of the image sequences, the user rotates their torso to a new orientation as shown in the user device camera view while maintaining the same distance away from the user device camera. In this manner, each captured image of the sequence represents a unique rotational view of the user torso.

The user device captures a sequence of images (or video) with the user positioned at a range of various orientations. For instance, in one non-limiting example the user device captures seven still images at the following orientations: chest wall facing toward the camera, chest wall facing 45° clockwise from the camera, chest wall facing 135° clockwise from the camera, chest wall facing 180° clockwise from the camera, chest wall facing 225° clockwise from the camera, chest wall facing 315° clockwise from the camera, and chest wall facing toward the camera.

Referring now to FIG. 3B, a flow diagram illustrating an alternative process to acquire user breast image data is shown. The user creates a personal profile and enters design preferences into the user device which the mobile application stores (in box 310). The mobile application displays instructions to the user for positioning the user device (in box 312). The user positions the user device in a stable location such that the user device camera has an unobstructed view of the user's torso. The user removes garments covering the breasts.

The mobile application displays instructions to the user for image capture (in box 314). The mobile application displays instructions to the user including instructions to position the user device such that user's torso is within the camera view. The mobile application displays instructions on the user device including instructions to capture one or more images (or video) of the user's torso and stores the image(s) or video in memory.

The mobile application validates the images and prompts the user for customization (in box 316) of the garment. For example, customizations of the garment can include but are not limited to fabric type and color, pattern customization, stitching type and color, embroidery, band type and width, and selection of hardware (e.g., buttons, zippers, and/or hooks). In some embodiments, the mobile application, the mobile application can transmit captured images and/or customizations for processing on a networked device (e.g., over the internet).

A schematic diagram of the process of FIG. 3A is shown in FIG. 4. A user 400 is shown a distance 410 from the user device 420. The distance separating the user device 420 and user 400 is sufficient to capture the left and right breasts within the image including, for example, between 2 feet and 6 feet. User 400 is shown facing the user device 420.

Surrounding the user 400 is a series of example orientations 402a-f to which the user orients between sequential images captured by the user device 400. For example, 402a represents a right perspective image, 402b represents a right profile image, 402c represents a right rear perspective image, 402d represents a left rear perspective image, 402e represents a left profile image, and 402f represents a left perspective image. The example of FIG. 4 shows six orientations 402a-f, though more or fewer can be used in some embodiments. For example, the user device 400 can capture more than six images at corresponding unique orientations 402. In some embodiments, additional instructions and scanning positions may be required. In some embodiments, video image(s) may be used.

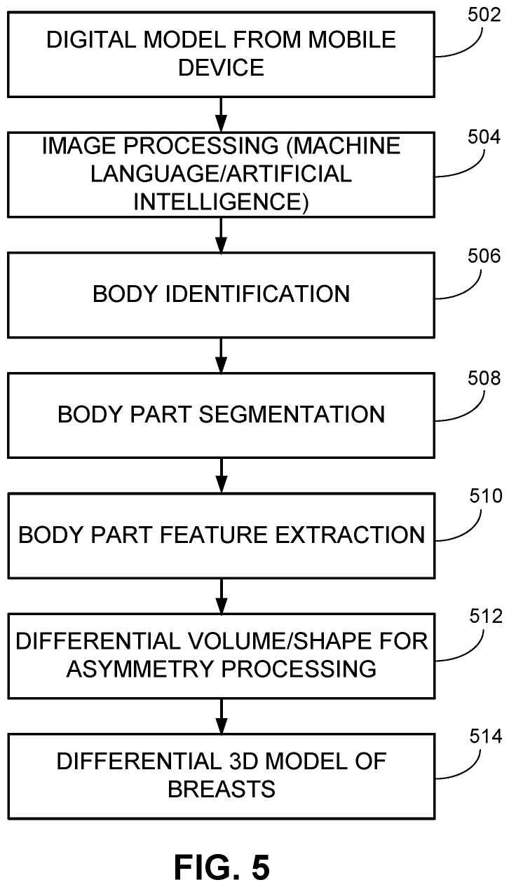

FIG. 5 is an example flow diagram illustrating a process for image processing in which the digital model is created, processed by a computing device, breast and chest wall asymmetries are identified, and a differential 3D model of the breasts created. The differential model is then utilized for the manufacturing of garments to correct for asymmetries.

The user device (or a networked computer system) determines a digital model from the images captured by the camera device (in box 502). Image capture can include a number of digital image capture techniques, including but not limited to computer vision, point cloud modeling, and depth data extraction. For example, a first example method of still image capture includes capturing multiple still image frames during a scan, and extracting depth data associated with each of those frames.

Additional image processing to create a 3D reconstruction and labeling of anatomical parts can take place on the user device or, for example, on a networked computing device (e.g., an image processing server) (in box 504). In some embodiments, the user device can transmit the digital model to a networked computing device that receives the digital model from the mobile device over a wired or wireless network (e.g., Wi-Fi, Bluetooth, or the internet). In some embodiments, the image processing is performed with machine learning (ML) models, such as supervised or unsupervised machine learning techniques. In further examples, the image processing includes morphological image processing to extract image components representing anatomical landmarks of the chest wall and breasts. Additional processing of the digital models allows for body identification (in box 506). Body identification selects data from the digital model representing the body of the user.

Segmentation (in box 508) of the digital model is performed to identify body parts. In some embodiments, segmentation of the digital model, or a body part of the digital model, into depth slices is performed using a depth slicing technique. Each still image frame of the digital model includes an array of pixels, each pixel including color and depth data. For example, still images collected using dual camera imaging or infrared point cloud imaging contain depth data associated with each pixel. For example, a point cloud imaging camera deploys more than 10,000 infrared beams which reflect from objects in the camera field of view. The reflected information is analyzed to determine a distance from the camera for each reflected beam to determine depth information for each pixel. The networked computing device calculates an average pixel depth across all pixels of the frames to account for noise in the still images. In some embodiments, the depth data is separated from the color data and an array of depth data would be created from the still images.

The networked computing device calculates a depth slice interval based upon on the distance between the measured chest wall distance and nipple distance. Some examples of determining the depth slice interval include a pre-determined number of depth slices, a minimum number of depth slices, or a fixed spatial depth slice interval (e.g., 0.5 mm, 1 mm, or 2 mm). A range of depths will be binned (e.g., filtered) from the depth array thereby creating a segment (e.g., “depth slice”) at a specific distance from the camera. The range of depths will determine the slice thickness. More than one segment can be combined into a digital file representing the segmented digital model.

From the segmented digital model, the networked computing device further performs body part feature extraction (in box 510) to determine and label anatomical landmarks (e.g., body parts) of the torso, chest wall, and breasts such as the sternal notch, xiphoid, nipple, areola, inframammary fold or anterior axillary line. For example, the depth slice most proximal to the camera may contain at least portion of the user's nipple, the next slice would contain the tissue one slice thickness distal from the camera, and so on until the depth slice detects the chest wall. In some embodiments, the data array can be used to determine distances such inter-nipple distance, e.g., the distance between each nipple in 3D space in relation to the distance between positions of each nipple in the 2D pixel array.

The image processing further includes determining asymmetries in volume, shape, position, and/or projection of the breasts (in box 512). The networked computing device utilizes a subtraction algorithm to determine asymmetries of the breasts and chests wall.

The determination of asymmetries present in the digital model results in a differential digital model (in box 514). A differential digital model can be called a differential 3D model.

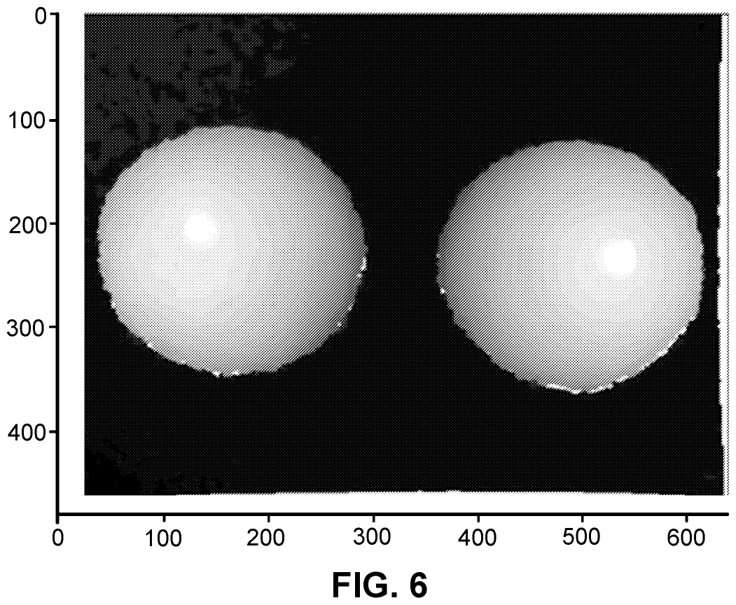

FIG. 6 is a 3D model visualization of an exemplary set of the depth slices corresponding to a digital model (e.g., breast model) imaged during testing. User nipples are shown in white as the most proximal depth slices to the user device camera while the black area corresponds to the most distal depth slice, such as the chest wall. The intervening breast volume is represented in depth slices colored in grayscale to depict their distance from the camera, lighter shaded slices being more proximal to the camera and darker shades being more distal.

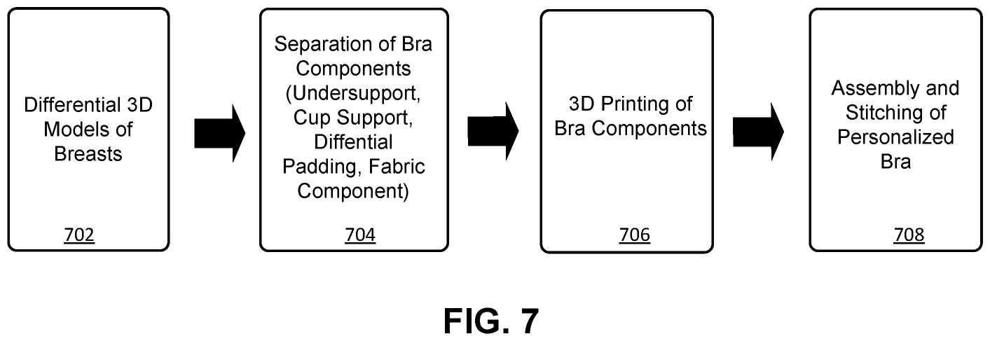

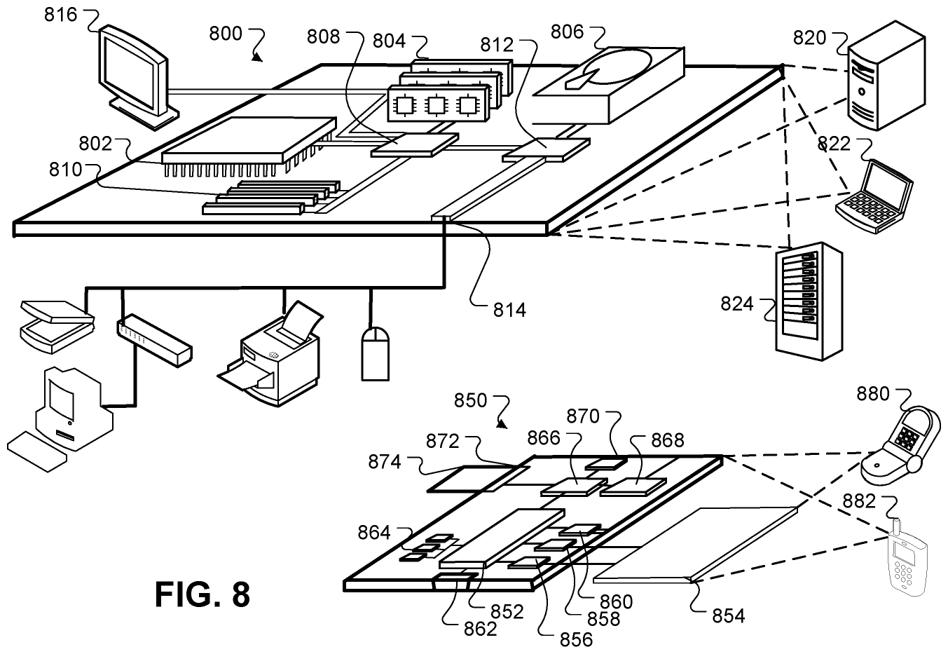

FIG. 7 shows a flow diagram of the process to create a customized garment from the differentiated digital model (such as FIG. 6). The differential digital model will be uploaded to a networked additive printing system (e.g., 3D printer) (in box 702). The network can include any network described herein. Examples of additive printing systems include vat photopolymerization, material extrusion, sheet lamination, powder bed fusion, binder jetting, material jetting, or directed energy deposition.

The additive printing system separates the differentiated digital model into bra components (in box 704). Components that may be additive printed include structural elements of the bra such as the under support (e.g., underwire), cup support, or differential padding to correct breast or chest asymmetries.

The additive printing system prints the components of the customized garment (in box 706). The components (e.g., under support, cup support, differential padding) can be printed as an integrated single element, linked as a hinged system, or separately for later assembly. The printed components are used with garment manufacturing techniques to assemble the garment.

The customized garment is assembled (in box 708) such that the printed components and additional material is constructed together to form a finished product capable of being worn by the user and correcting for breast and chest asymmetries. In some embodiments, the user inputs additional customization elements before the components are printed and/or assembled. Examples of additional customization elements for design and fit include fabric, fabric color, thread, thread color, stitch pattern geometry, embroidery, clasps, hooks, or buttons. The user inputs into the application one or more preferences or customizations for one or more components of a customized garment (e.g., bra, swim suit, shirt, or dress). For example, the user can select an underwire color, material, cut, pattern, design, style, type, size, length, or select from preset options stored in the user device memory.

FIG. 8 shows example of user devices, such as a computing device 800 and a mobile computing device 850 that can be used as data processing apparatuses to implement the techniques described here. The computing device 800 is intended to represent various forms of digital computers, such as laptops, desktops, workstations, personal digital assistants, servers, blade servers, mainframes, and other appropriate computers. The mobile computing device 850 is intended to represent various forms of mobile devices, such as personal digital assistants, cellular telephones, smart-phones, tablets, and other similar computing devices.

The computing device 800 includes a processor 802, a memory 804, a storage device 806, a high-speed interface 808 connecting to the memory 804 and multiple high-speed expansion ports 810, and a low-speed interface 812 connecting to a low-speed expansion port 814 and the storage device 806. Each of the processor 802, the memory 804, the storage device 806, the high-speed interface 808, the high-speed expansion ports 810, and the low-speed interface 812, are interconnected. The processor 802 can process instructions for execution within the computing device 800, including instructions stored in the memory 804 or on the storage device 806 to display graphical information for a GUI on an external input/output device, such as a display 816.

The memory 804 stores information within the computing device 800. The storage device 806 is capable of providing mass storage for the computing device 800. Instructions can be stored in an information carrier. The instructions, when executed by one or more processing devices (for example, processor 802), perform one or more methods, such as those described above. The instructions can also be stored by one or more storage devices such as computer or machine-readable mediums (for example, the memory 804, the storage device 806, or memory on the processor 802).

The computing device 800 may be implemented in a number of different forms, as shown in the figure. For example, it may be implemented as a standard server 820, or multiple times in a group of such servers. In addition, it may be implemented in a personal computer such as a laptop computer 822 or as part of a rack server system 824.

The mobile computing device 850 includes a processor 852, a memory 864, an input/output device such as a display 854, a communication interface 866, and a transceiver 868, among other components, such as a camera. Each of the processor 852, the memory 864, the display 854, the communication interface 866, and the transceiver 868, are interconnected.

The processor 852 can execute instructions within the mobile computing device 850, including instructions stored in the memory 864. The processor 852 may be implemented as a chipset that includes separate and multiple analog and digital processors. The processor 852 may provide, for example, for coordination of the other components of the mobile computing device 850, such as control of user interfaces, applications run by the mobile computing device 850, and wireless communication by the mobile computing device 850.

The processor 852 may communicate with a user through a control interface 858 and a display interface 856 coupled to the display 854. The display 854 may be, for example, a TFT (Thin-Film-Transistor Liquid Crystal Display) display or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may provide communication with the processor 852, so as to enable near area communication of the mobile computing device 850 with other devices. The external interface 862 may provide, for example, for wired communication in some implementations, or for wireless communication in other implementations, and multiple interfaces may also be used.

The memory 864 stores information within the mobile computing device 850. In some implementations, instructions are stored in an information carrier. The instructions, when executed by one or more processing devices (for example, processor 852), perform one or more methods, such as those described above. The instructions can also be stored by one or more storage devices, such as one or more computer or machine-readable mediums (for example, the memory 864, the expansion memory 874, or memory on the processor 852).

The mobile computing device 850 may communicate wirelessly through the communication interface 866, which may include digital signal processing circuitry where necessary. The mobile computing device 850 may be implemented in a number of different forms, as shown in the figure. For example, it may be implemented as a cellular telephone 880. It may also be implemented as part of a smart-phone 882, personal digital assistant, or other similar mobile device.

These computer programs (e.g., the application) described herein include machine instructions for a programmable processor, and can be implemented in a high-level procedural and/or object-oriented programming language, and/or in assembly/machine language.

To provide for interaction with a user, the systems and techniques described here can be implemented on a computer having a display device (e.g., an OLED (organic light emitting diode) display or LCD (liquid crystal display) monitor) for displaying information to the user and a keyboard and a pointing device (e.g., a mouse or a trackball) by which the user can provide input to the computer. Input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

1. A method comprising:
receiving, by a computing system, multiple digital images of a torso of a subject that has an anatomical asymmetry;
processing, by the computing system, the multiple digital images to create a digital model of the anatomical asymmetry; and
creating, based on the model and using an additive manufacturing process, one or more components of a garment for the subject that reduces an appearance of the anatomical asymmetry.

2. The method of claim 1, further comprising assembling the garment including the one or more components.

3. The method of claim 1, wherein the anatomical asymmetry is a breast asymmetry, or a chest asymmetry.

4. The method of claim 1, wherein the garment is a bra, a swimsuit, a blouse, a lingerie, an athletic wear, a protective sportswear, or a gown.

5. The method of claim 1, wherein the multiple digital images of the torso of the subject includes three or more digital images at differing angles between the torso of the subject and a camera that captures the three or more digital images.

6. The method of claim 1, wherein the processing is performed using a machine learning model.

7. The method of claim 6, wherein the machine learning model is a supervised machine learning model.

8. The method of claim 6, wherein the machine learning model is an unsupervised machine learning model or a computer vision model.

9. (canceled)

10. The method of claim 1, wherein the processing includes morphological image processing to extract image components representing anatomical components of the subject.

11. The method of claim 1, wherein the digital model is a digital three-dimensional model.

12. The method of claim 1, wherein the processing includes body identification that selects data from the model.

13. The method of claim 1, wherein the multiple digital images of the torso of the subject includes a video that having three or more digital images at differing angles between the torso of the subject and a camera that captures the three or more digital images.

14. A system for customized bra component manufacturing, the system comprising:
a digital camera;
a computing system; and
an additive manufacturing process comprising a three-dimensional printer, wherein the computing system is configured to:
receive multiple digital images of a torso of a subject that has an anatomical asymmetry, wherein the multiple digital images are captured by the digital camera; and
process the multiple digital images to create a digital model of the anatomical asymmetry; and
wherein the additive manufacturing process is configured to create, based on the model, one or more components of a garment for the subject that reduces an appearance of the anatomical asymmetry.

15. (canceled)

16. The system of claim 14, wherein the anatomical asymmetry is a breast asymmetry, or a chest asymmetry.

17. The system of claim 14, wherein the garment is a bra, a swimsuit, a blouse, a lingerie, an athletic wear, a protective sportswear, or a gown.

18. The system of claim 14, wherein the digital model is a digital three-dimensional model.

19. The system of claim 14, wherein the digital camera is a component of a smart phone or tablet computer.

20. The system of claim 19, wherein the computing system is fully or partially located on the smart phone or tablet computer.

21. (canceled)

22. (canceled)

23. The system of claim 14, wherein the digital camera is a video camera, and wherein the multiple digital images are from a video captured by the video camera.

24. A non-transitory computer readable storage device storing instructions that, when executed by at least one processor, cause the at least one processor to perform operations comprising:
receiving, by a computing system, multiple digital images of a torso of a subject that has an anatomical asymmetry;
processing, by the computing system, the multiple digital images to create a digital three-dimensional model of the anatomical asymmetry; and
creating, based on the model and using an additive manufacturing process, one or more components of a garment for the subject that reduces an appearance of the anatomical asymmetry.
